(19) United States
(12) Patent Application Publication
(10) Pub. No.: US 2021/0304632 A1
(43) Pub. Date: Sep. 30, 2021

(54) DYNAMIC SCENARIO CREATION IN VIRTUAL REALITY SIMULATION SYSTEMS

(71) Applicant: Street Smarts VR, New York, NY (US)

(72) Inventors: Jeffrey Jarrard, New York, NY (US); Alice Formwalt, New York, NY (US)

(21) Appl. No.: 17/203,480

(22) Filed: Mar. 16, 2021

Related U.S. Application Data
(60) Provisional application No. 62/990,097, filed on Mar. 16, 2020.

(51) Int. Cl. G09B 9/00; G06T 13/20; G06F 3/0484; G06F 9/445; G06F 16/16; G06F 16/17

(52) U.S. Cl. CPC G09B 9/00; G06T 13/20; G06F 3/04847; G06F 9/44521; G06F 3/0482; G06F 16/173; G06T 2213/08; G06T 2200/24; G06F 16/168

(57) ABSTRACT

A method and system for creating dynamic scenarios, the system comprising a processor and a memory having executable instructions stored thereon that when executed by the processor cause the processor to execute virtual reality training software including a scenario editor that is selected by a user to create a dynamic scenario, generate the dynamic scenario by creating a folder including customizable files corresponding to a scene of the dynamic scenario, create a window including a project view of the customizable files that provides access to properties of a scenario information file including configurable scenario settings, and generate animator controllers including state machines that are linked with animated characters or items, the animator controllers controlling animation behaviors of the animated characters or items in the dynamic scenario.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED APPLICATION

This application claims the priority of U.S. Provisional Application No. 62/990,097, entitled “DYNAMIC SCENARIO CREATION IN VIRTUAL REALITY SIMULATION SYSTEMS,” filed on Mar. 16, 2020, the disclosure of which is hereby incorporated by reference in its entirety.

### BACKGROUND OF THE INVENTION

### Field of the Invention

This application generally relates to interactive virtual reality systems, and in particular, to the development of variable virtual reality content or experiences in virtual reality simulations.

### Description of the Related Art

Virtual reality systems may offer a unique form of entertainment and training. A virtual reality environment may refer to an immersive virtual world/space experience that users may interact with. Increased interest in virtual reality as an industry and improvements made in virtual reality technology have expanded virtual reality usage. However, traditional scriptwriting tools are not well-suited to the creation of virtual reality content due to the various complexities associated with the more immersive environment realized with virtual reality content. Producing virtual content involves the careful use of sound, light, and movement to present a cohesive virtual reality experience.

Furthermore, many typical virtual reality environments that are used for real-world training are suited for only a small number of users. For example, multiple characters may perform certain predefined and coordinated animations. Traditional solutions to the problem of which characters and actions to include in particular interaction scenarios and which interaction scenarios are appropriate for the presently available game characters and context are clumsy and inefficient.

There is thus a need to provide virtual reality environments that are suitable for a larger number of users.

### SUMMARY OF THE INVENTION

The present invention provides a method and system for creating dynamic scenarios. According to one embodiment, the system comprises a processor and a memory having executable instructions stored thereon that when executed by the processor cause the processor to execute virtual reality training software including a scenario editor that is selected by a user to create a dynamic scenario, generate the dynamic scenario by creating a folder including customizable files corresponding to a scene of the dynamic scenario, present a window including a project view of the customizable files that provides access to properties of a scenario information file including configurable scenario settings, and generate animator controllers including state machines that are linked with animated characters or items wherein the animator controllers controlling animation behaviors of the animated characters or items in the dynamic scenario.

The animator controllers may include configurable machine states corresponding to the animated characters or items. The animator controllers may be configured to control flow between the configurable states based on transitions and parameters. The configurable machine states may include actions and idles of the animated characters or items. In one embodiment, the processor may be further configured to use transitions to control flow between machine states corresponding to the animated characters or items via the animator controllers. In another embodiment, the processor may be further configured to graphically rendering the transitions with line arrows between an origin state and a destination state.

The virtual reality computing system may further comprise the processor configured to generate an animator override controller object, the animator override controller object synchronizing animated characters or items from a plurality of the animator controllers. The processor may also be configured to generate animator audio sync scripts wherein the animator audio sync scripts adding sound to the dynamic scenario. The animator audio sync scripts may associate audio sources with animation data objects of the animated characters or items. The animator audio sync scripts may associate audio sources with the animator controllers.

According to one embodiment, the method comprises executing virtual reality training software including a scenario editor that is selected by a user to create a dynamic scenario, generating the dynamic scenario by creating a folder including customizable files corresponding to a scene of the dynamic scenario, creating a window including a project view of the customizable files that provides access to properties of a scenario information file including configurable scenario settings, and generating animator controllers including state machines that are linked with animated characters or items wherein the animator controllers controlling animation behaviors of the animated characters or items in the dynamic scenario.

The animator controllers may include configurable machine states corresponding to the animated characters or items. Flow between machine states corresponding to the animated characters or items may be controlled with transitions via the animator controllers. The method may further comprise graphically rendering the transitions with line arrows between an origin state and a destination state. An animator override controller object may be generated wherein the animator override controller object synchronizing animated characters or items from a plurality of the animator controllers. Animator audio sync scripts may also be generated wherein the animator audio sync scripts adding sound to the dynamic scenario. The animator audio sync scripts may associate audio sources with animation data objects of the animated characters or items. The animator audio sync scripts may also associate audio sources with the animator controllers.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates an exemplary scenario library screen according to an embodiment of the present invention.

FIGS. 3 through 14 illustrate exemplary interfaces of a dynamic scenario editor according to an embodiment of the present invention.

FIGS. 15 through 24 illustrate exemplary scripts according to embodiments of the present invention.

FIGS. 25 and 26 illustrate exemplary previewing within a dynamic scenario editor according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Systems and methods described herein are directed to simulations in virtual reality environments for providing training, education, or entertainment. The presently disclosed system may identify and select characters, assign roles, select interaction scenarios, and coordinate playing scenarios while aligning the characters. Dynamic scenarios, as disclosed herein, may refer to content creation that allow for additional flexibility in scenario development and re-usage. Content may be created by using a system including animator controllers combined with custom features to handle multiple branches and provide fine-tuned character control.

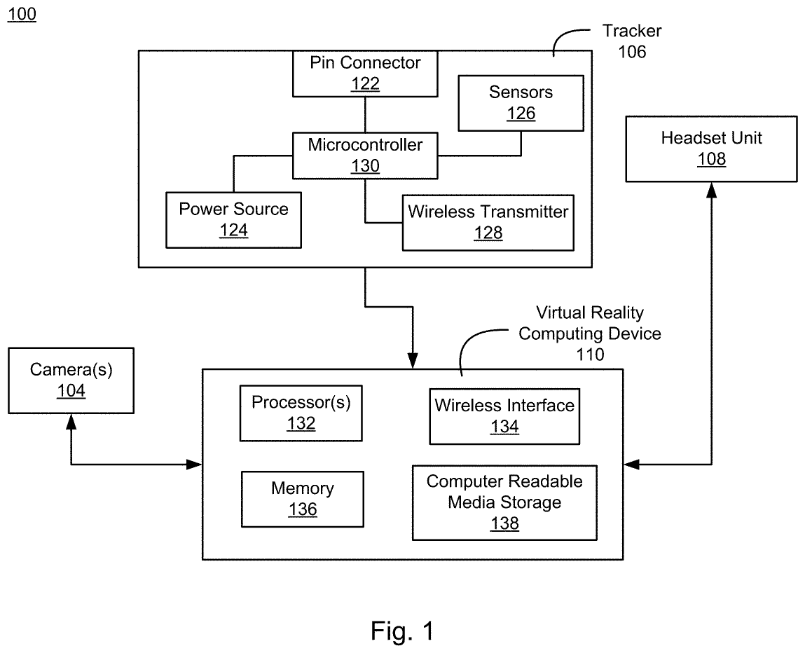

FIG. 1 presents a virtual reality computing system according to an embodiment of the present invention. A system 100 may include camera(s) 104, tracker 106, headset unit 108, and virtual reality computing device 110. Camera(s) 104 can monitor the actions of a user by using, for example, a “marker” that is placed on the user or placed on handheld devices (not illustrated). A marker may either be a small reflective surface or a small light. In one embodiment, by using multiple cameras, the position and orientation of a set of markers may be calculated using triangulation methods.

Users may interact with the virtual reality computer system through the manipulation of handheld devices. Handheld devices may be coupled to tracker 106. Tracker 106 includes pin connector 122, power source 124, sensors 126, wireless transmitter 128, and microcontroller 130. Sensors 126 can monitor the handheld devices and transmit data to virtual reality computing device 110 to interpret the motions of the user and dynamically change a virtual reality environment based on the motions of the user.

The handheld devices may include a pin pad that can be communicatively or electrically connected to pin connector 122. Power source 124 may be connected to microcontroller 130 and used by microcontroller 130 to provide a voltage source to the handheld devices via pin connector 122. As such, microcontroller 130 may receive signals from closed electrical circuits connected to pin connector 122 and transmit the signals to virtual reality computing device 110 via wireless transmitter 128. Virtual reality computing device 110 may process the signals using processor(s) 132 and transmit corresponding images to headset unit 108 from wireless interface 134.

Microcontroller 130 may also provide power to sensors 126 and wireless transmitter 108 from power source 124. Sensors 126 can detect a position of tracker 106 within the x, y and z coordinates of a space, as well as orientation including yaw, pitch and roll. From a user's perspective, a handheld device connected to tracker 106 may be tracked when pointed up, down, left and right, tilted at an angle, or moved forward or backwards. Sensors 126 may communicate where the handheld device is oriented to microcontroller 130 which sends the data to virtual reality computing device 110 for processing by processor(s) 132 and renders corresponding images for transmission by wireless interface 134 to headset unit 108.

Headset unit 108 may comprise a head mounted display that a user can place over their eyes. The headset unit 108 may be configured to communication with the virtual reality computing device 110 to provide display according to a virtual reality simulation program. Additionally, the headset unit 108 may be configured with positioning and/or motion sensors to provide user motion inputs to virtual reality computing device 110. When wearing the headset unit 108, the view may shift as the user looks up, down, left and right. The view may also change if the user tilts their head at an angle or move their head forward or backward without changing the angle of gaze. Sensors on headset unit 108 may communicate to processor(s) 132 where the user is looking, and the processor(s) 132 may render corresponding images to the head mounted display. Sensors, as disclosed herein, can detect signals of any form, including electromagnetic signals, acoustic signals, optical signals and mechanical signals.

Virtual reality computing device 110 includes processor(s) 132, wireless interface 134, memory 136, and computer readable media storage 138. Processor(s) 132 may be configured to execute virtual reality training software stored within memory 136 and/or computer readable media storage 138, to communicate data to and from memory 136, and to control operations of the virtual reality computing device 110. The processor(s) 132 may comprise central processing units, auxiliary processors among several processors, and graphics processing units. Memory 136 may include any one or combination of volatile memory elements (e.g., random access memory (RAM). Computer readable media storage 138 may comprise non-volatile memory elements (e.g., read-only memory (ROM), hard drive, etc.). Wireless interface 134 may comprise a network device operable to connect to a wireless computer network for facilitating communications and data transfer with tracker 106 and headset unit 108.

The virtual reality training software may comprise an audio/visual interactive interface that enables a trainee to interact with a three-dimensional first-person-view environment in training scenarios with tracker devices or handheld devices connected to the tracker devices, such as weapons including virtual reality-enabled magazine assemblies as described in commonly owned U.S. Patent Application No. 62/874,234, entitled “MAGAZINE SIMULATOR FOR USAGE WITH WEAPONS IN A VIRTUAL REALITY SYSTEM” which is herein incorporated by reference in its entirety. Virtual reality computing device 110 may receive signals or commands from tracker 106 and headset unit 108 to generate corresponding data (including audio and video data) for depiction in the virtual reality environment.

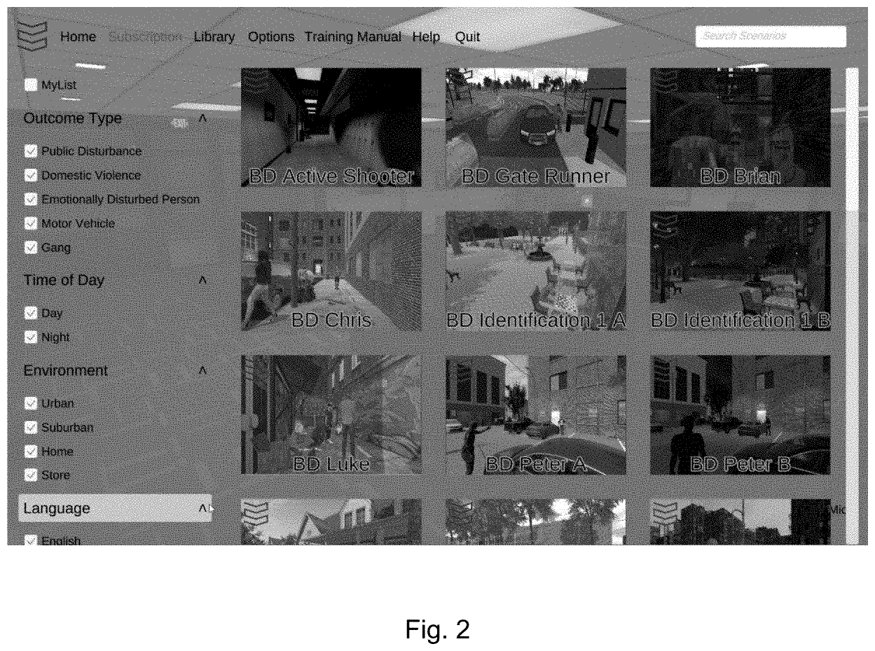

Virtual reality training software may include a scenario library, as illustrated in FIG. 2. The scenario library may include a plurality of scenarios available for selection and execution by the virtual reality computing device. A scenario may comprise a programmed simulation containing a given situation, setting, characters, and actions. A user may filter scenarios by type, time of day, environment, and/or language on the scenario library screen.

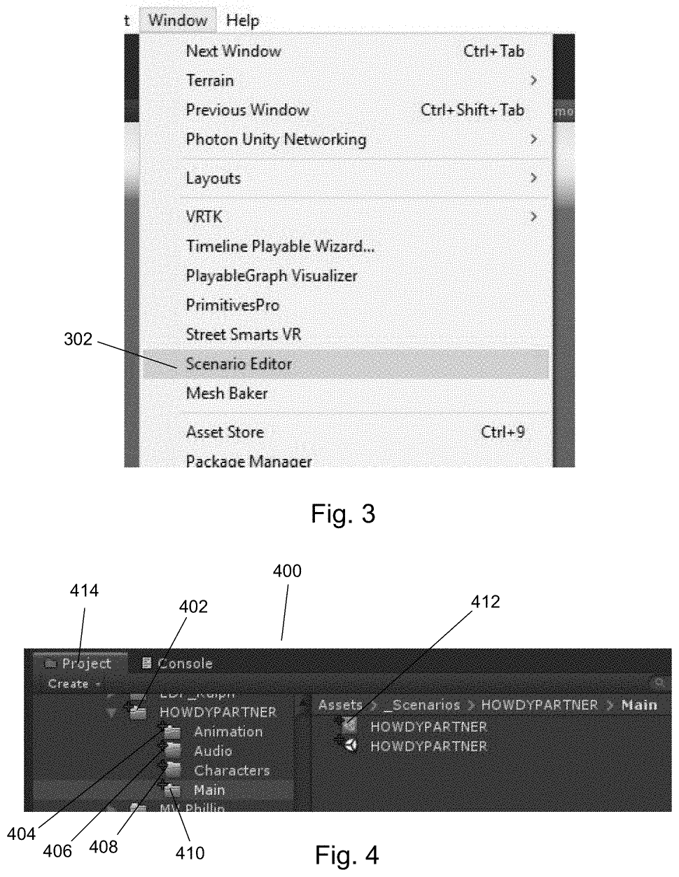

As shown in FIG. 3, a scenario editor 302 may be selected from a menu of a virtual reality training software program to create a new base dynamic scenario or edit an existing dynamic scenario. The scenario editor 302 may initialize a dynamic scenario creator wizard to create a new scenario. Creating the new scenario may include creating a new folder including a title of the new scenario and pre-populating the new folder with building block files for the new dynamic scenario. The new folder may then be selected to generate a window 400 that presents to the user a project view 414 of files in the new folder corresponding to a scene of the new scenario, such as shown in FIG. 4. In the illustrated example, a new scenario folder 402 named “HOWDYPARTNER” has been created. The new scenario folder 402 may be provided with customizable building block files for a dynamic scenario that are contained in folders “animation” 404, “audio” 406, “characters” 408, and “main” 410.

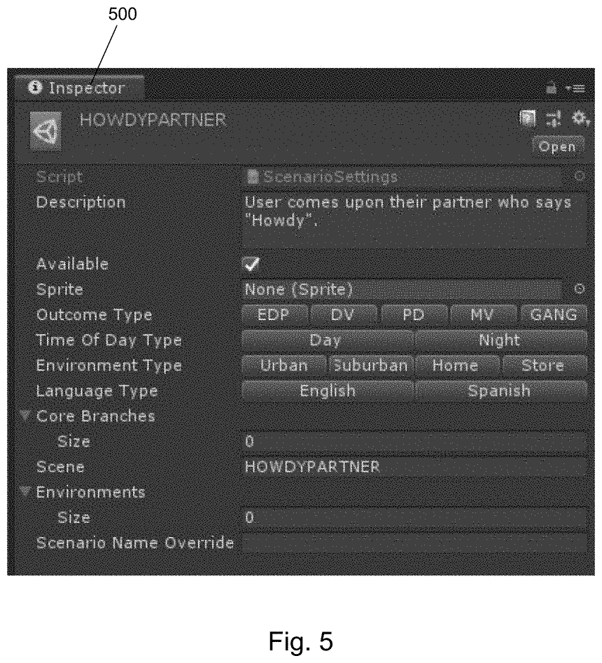

A scenario information file 412 may be accessed from the window 400 to configure scenario settings. For example, the scenario information file 412 contained in the “main” folder 410 may be selected in the project view 414 to show its properties in an “inspector view” 500, as illustrated in FIG. 5. Information may be added or changed in the scenario information file 412, such as a description of the scene, “sprite” which represents the icon for the scene in a menu view, outcome type, time of day, environment type, language, number of core branches, scene name, and environment size. A “Scenario Name Override” may be entered for presenting a name that is shown to a user through the in-game/in-simulation user interface.

Animator controllers may be added to the dynamic scenario files. Animator controllers may comprise state machines that can be linked or associated with animated characters or items to control their animation behaviors in the scenario. During a scenario editor creation process, the dynamic scenario creator wizard may create an animator controller from an existing template. Animator controllers may be viewed and selected from the “animation” folder 404.

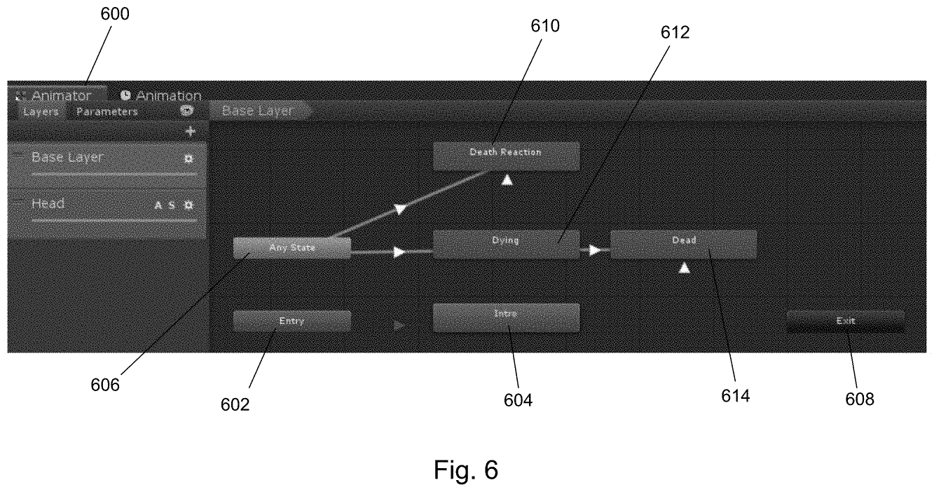

FIG. 6 presents an animator controller view according to an embodiment of the present invention. States represent and include the actions and idles (of animated characters or items) that make up a scenario. The illustrated template may provide the animator controller with default states of animated characters or items that may be configured, such as “Entry” 602, “Intro” 604, “Any State” 606, and “Exit” state 608. The template may also provide “Death Reaction” 610 as well as death states (e.g., “Dying” 612 and “Dead” 614) to get the user started. The “Intro” state 604 may be created to house the initial animations of the scene. The “Any State” 606 may comprise a special state that allows to instantly transition from any point in the state machine. This is especially useful for death animation states 612 and 614, death reaction state 610, or any triggered scenario event. Transitioning from “Any State” 606 may require “Conditions” to prevent the target state from being called and the animator getting stuck. The death animation may be a special case driven by code that must follow certain guidelines e.g., “Dying” and “Dead.”

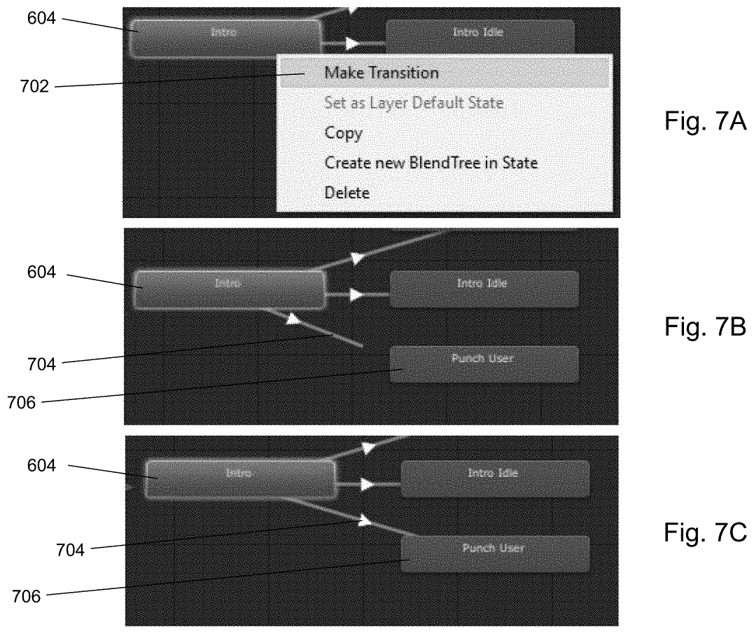

To create a new state, a user may either A) right click anywhere in the animator controller view and select “Create state>Empty”; or B) drag a desired animation data object for a core state into the animator window. Depending on how it was created, the state may be named either “New State” or the same as the animation data object. The animator controller may be configured to control the flow between machine states using “transitions” which may be defined by “parameters.” Transitions may be created for each state by, for example, right clicking on an origin intro state 604 and selecting “Make Transition” 702, as illustrated in FIG. 7A. This may create a new line arrow 704 between the origin state (intro state 604) and a mouse cursor (FIG. 7B) used to click on a destination state 706 that the user wishes to transition into to complete the transition creation (FIG. 7C).

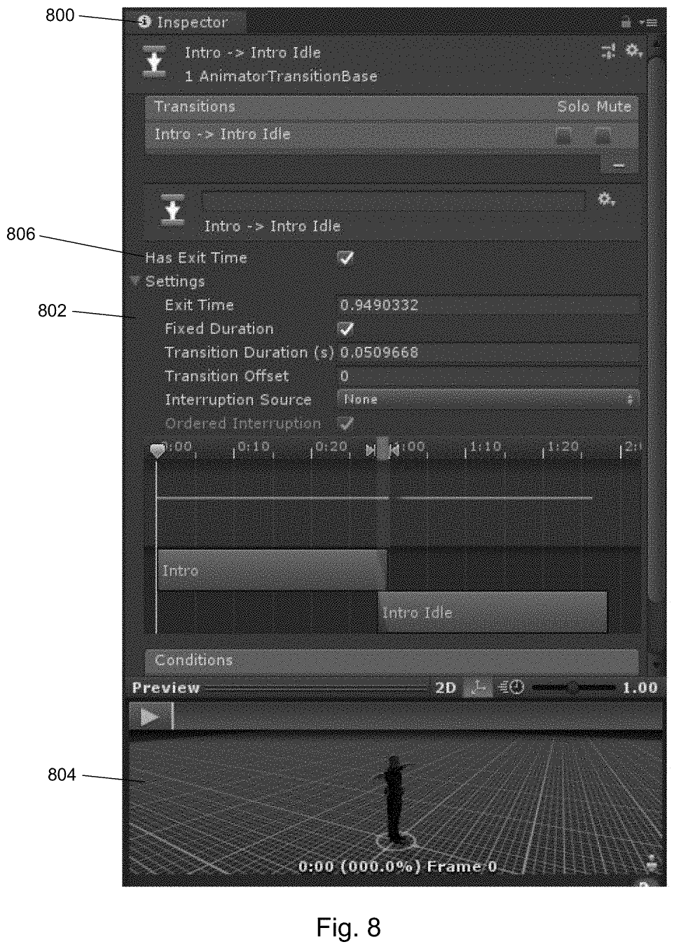

A transition may be selected to bring up the inspector view (FIG. 8). If both origin and destination states have animation data objects configured, a user may adjust transition timing settings 802 and preview (804) what the transition will look like within the inspector view 800. The inspector view 800 may include a “Has Exit Time” checkbox 806 that controls whether the origin animation waits until the end before transitioning. Smoother looking transitions can be created by increasing the transition duration, but at the cost of trimming either the end of the origin animation or the beginning of the destination animation. It may be desirable to find the smallest transition time that will still look natural.

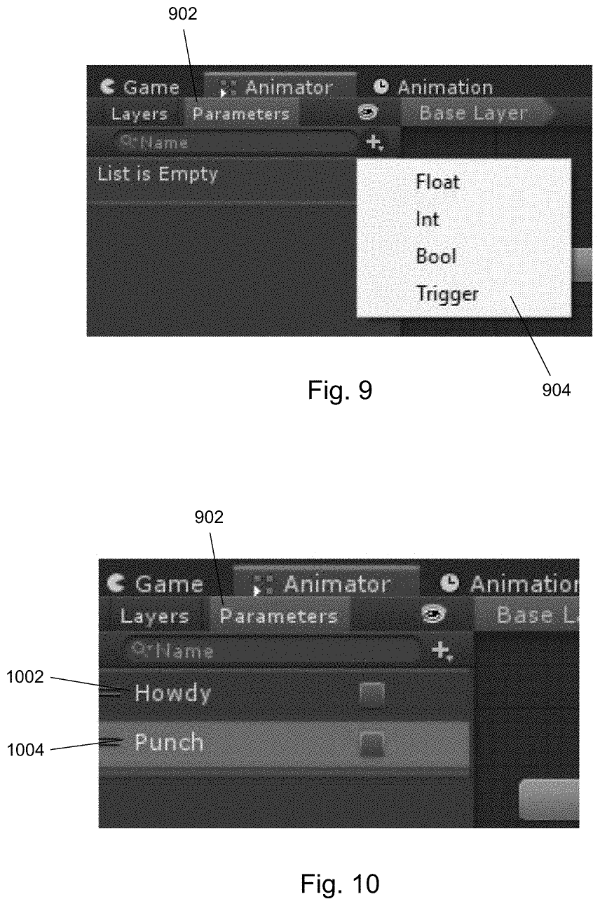

To guide the animator controller through the target states, parameters may be created to distinguish between the transitions. To create a parameter, a “Parameters” tab 902 in the top left of the animator window, as shown in FIG. 9, may be selected. The ‘+’ may be clicked to select the appropriate parameter type 904, for example, “Bool” (Boolean) may be selected. A parameter may be named relative to the state they lead to. For instance, to distinguish if a character will say “howdy” or punch the user, a Bool parameter is created for each state, e.g., a “Howdy” parameter 1002 and a “Punch” parameter 1004, as illustrated in FIG. 10. To associate parameters with a transition, an arrow line between two states representing the transition a user wishes to set, such as 704, may be selected.

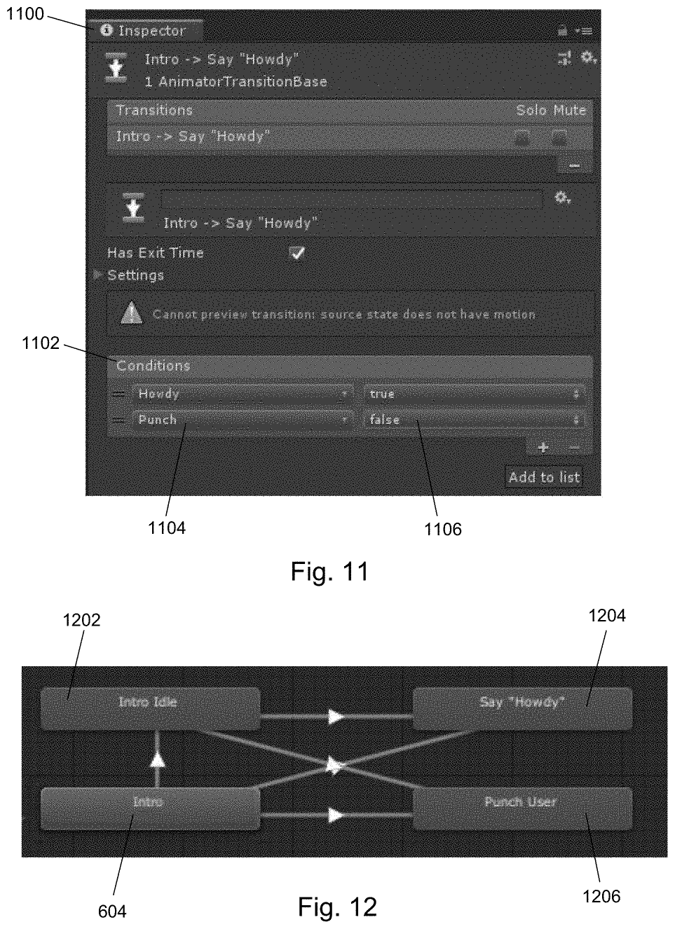

FIG. 11 presents an inspector view 1100 of the transition which shows details of the transition. Under “Conditions” 1102 the user may click the ‘+’ to add a condition or ‘-’ to remove a condition. The parameter dropdown 1104 may then be used to select the parameter to utilize and the Boolean dropdown 1106 to select ‘true’ or ‘false’ based on how the user wants to set the parameter. For choosing between multiple states, a parameter for each state may be required. The transition to each state may need one condition for where it wants to go, and one condition for each state it does not want to visit. The dynamic scenario creator may use these conditions to control how the parameters are set at runtime.

For example, referring to FIG. 12, a transition to “Say ‘Howdy’” state 1204 may need “Howdy” parameter 1002 set ‘true’ and “Punch” parameter 1004 set to ‘false’. The transition to “Punch User” state 1206 will conversely include conditions set for “Howdy” parameter 1002 to ‘false’ and “Punch” parameter 1004 to ‘true’. Scenes of a scenario may start in the “intro” state 604. The “intro” state 604 may include an animation and audio that introduce the user to the situation. The scene may transition from either the “Intro” state 604 or an “Intro Idle” state 1202 which plays until an option or action is selected. Two duplicate transitions may be needed—one set coming from the originating state (“Intro” state 604), and the other coming from the “Intro Idle” state 1202, with a default transition from the originating state to the “Intro Idle” state 1202. If the user selects an option during the “Intro” state 604, the state machine transitions directly to that option. Otherwise the “Intro Idle” state 1202 will play until an option is selected. For transitions between states that need to be played in their entirety, the transition can be set to “has exit time” so that transitions don't occur until the current animation is complete. For animations that can be exited as soon as the user selects the option (such as leaving “Intro Idle” state 1202), “has exit time” may be deselected in the transition so that it may exit as soon as an option is selected.

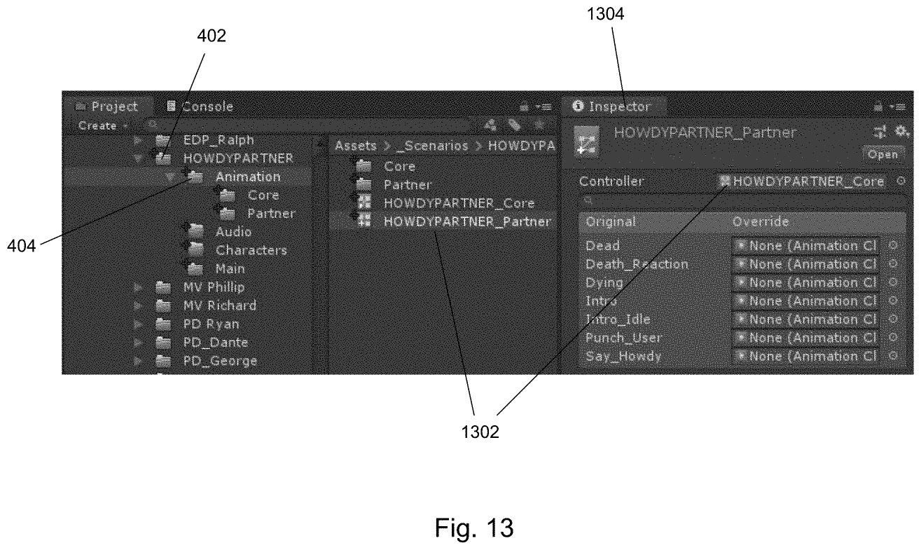

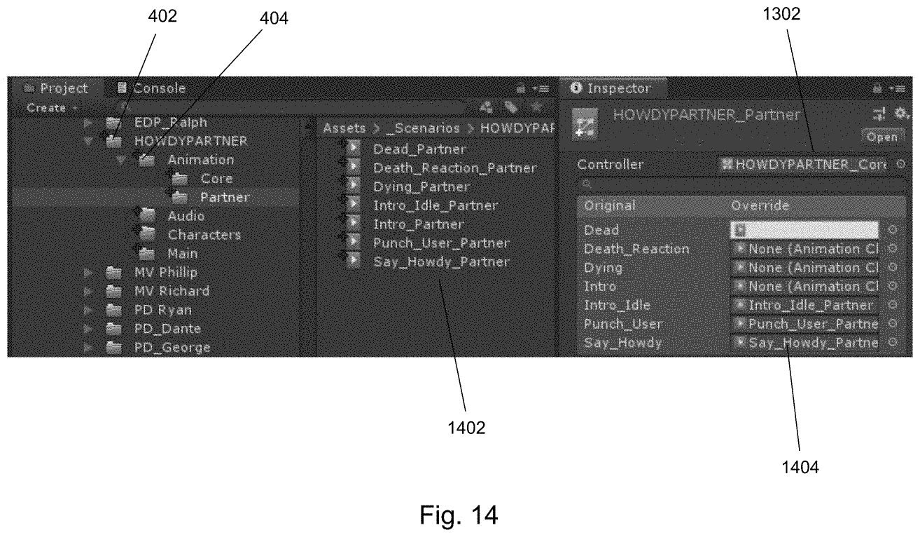

To keep animations of all objects and characters in sync throughout a scenario, the animations may all utilize a same core state machine. According to one embodiment, animator override controller objects may be created. An animator override controller may be created for each object to have unique animations. Referring to FIG. 13, a “HOWDYPARTNER_Partner” override controller 1302 is created by, for example, right clicking in the “Animation” folder 404 and selecting “Create”>“Animator Override Controller”. The override controller 1302 may be selected for inspector view 1304. In FIG. 14, any core animator controller (e.g., “Say_Howdy_Partner” 1402) for the scenario may be dragged into the “Controller” parameter slots (e.g., slot 1404) of the override controller 1302. For any animation to be overridden, the source for this character may be dragged into the “Controller” parameter slot corresponding to the overridden animation.

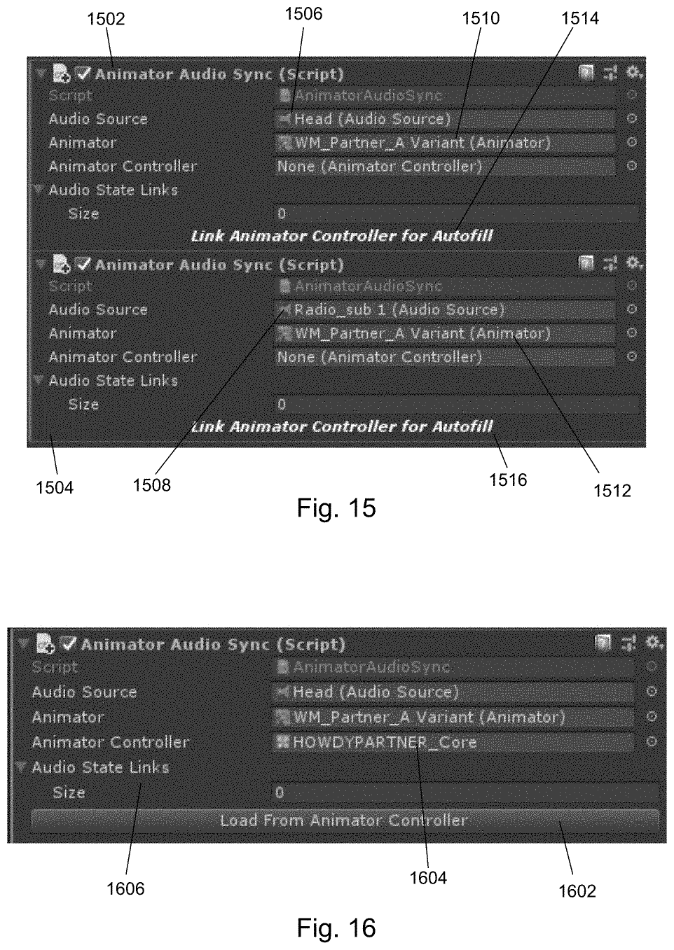

Adding sound to dynamic scenarios may be done utilizing animator audio sync scripts. A script may be needed for each controlled audio source. The scripts can be located anywhere (e.g., at the same level as the audio source itself) but for ease of access and organization it may be advised to keep them at a unified location per character or object. In FIG. 15, for instance, a partner character may be created with two animator audio sync scripts 1502 and 1504. Animator audio sync script 1502 may be created for an audio source 1506 that is added to a character's head for a partner voice and an animator audio sync script 1504 may be created for an audio source 1508 that is added to a radio for ambient radio sounds. Animator audio scripts can both be located at the base level of the character alongside the controlled animator for the character. Animator data objects may be dragged into the “Animator” parameter slots 1510 and 1512 for associating animation of the character with the audio sources. Once states have been laid out in a core animator controller, the animator controller may be used to automatically fill the state links as directed by “Link Animator Controller for Autofill” 1514, 1516.

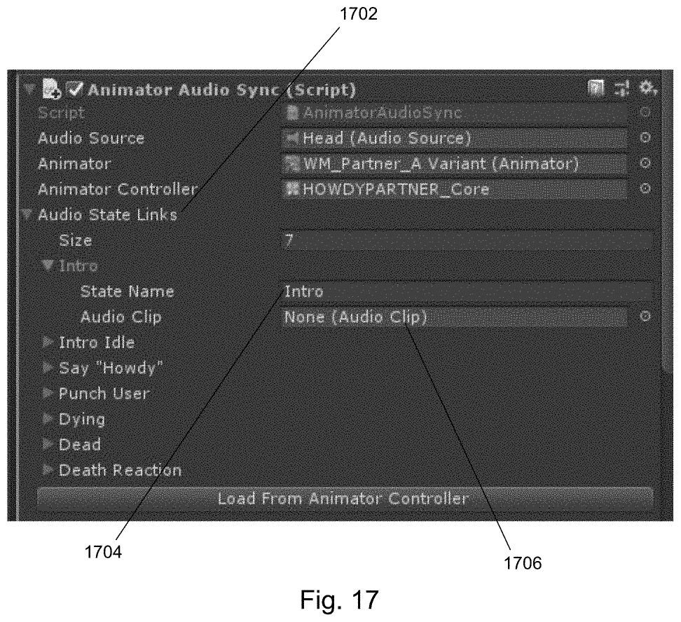

Referring to FIG. 16, a “Load From Animator Controller” button 1602 may be presented once a core animator controller, e.g., “HOWDYPARTNER_Core” has been selected or dragged into the “Animator Controller” parameter slot 1604. When the “Load From Animator Controller” button 1604 is pressed, the “Audio State Links” 1606 may populate with the states from the controller as shown in FIG. 17. Expanding each member of the “Audio State Links” 1702 may present the state name 1704 as well as the “Audio Clip” parameter slot 1706. Any audio clip may be dragged and dropped into the “Audio Clip” parameter slot 1706 and it will be played as the transition to the associated state begins. A state may be left blank. At runtime a blank audio clip may simply stop other audio on the source when transitioning into that state for that character or object.

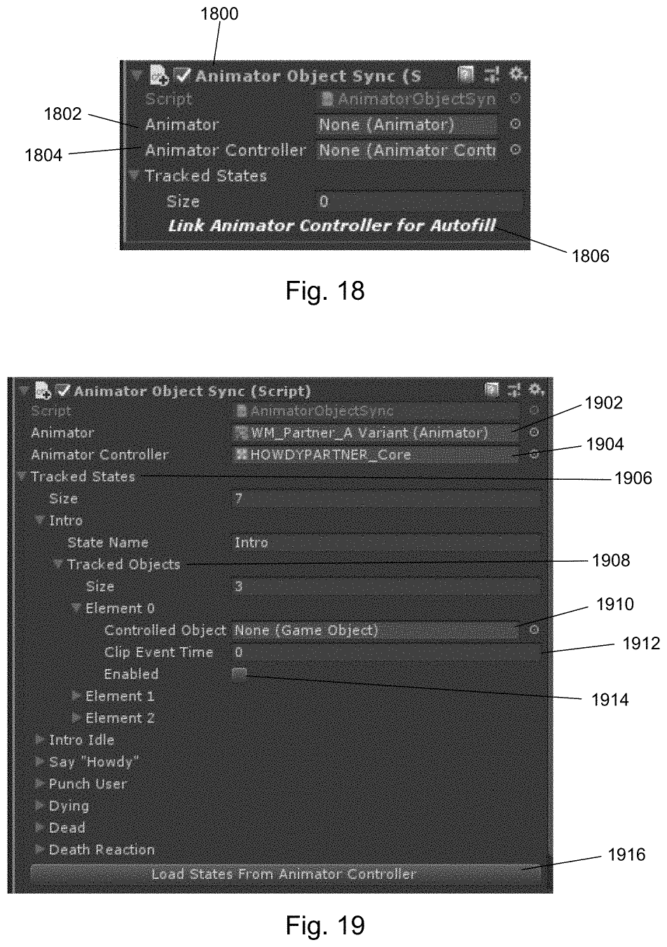

FIG. 18 presents an exemplary animator object sync script according to an embodiment of the present invention. For complex activation/deactivation of objects during a scenario, an animator object sync script may be created and used. As with the animator audio sync script, an animator object sync script 1800 can take an animator 1802 it is synced to as well as an animator controller 1804 to automatically fill the states. However, unlike an animator audio sync script, a new script is not needed for each controlled object. One script can be used to handle any number of objects in the scene, but that script can only be synced to one animator. If a character animator that the script is attached to gets killed in the scene or otherwise eliminated in the scenario, the activations and deactivations will not progress through the states along with the rest of the characters. For this reason, one animator object sync script may be used for each controlled animator.

When an animator controller 1804 is linked to the animator object sync script 1800, as indicated by 1806, states may be loaded based on the animator controller 1804 to configure tracked states. In the embodiment illustrated by FIG. 19, the animator 1902 is set to a “WM_Partner_A Variant” animator and the animator controller 1904 is set to a “HOWDYPARTNER_Core” controller. “Tracked States” 1906 may be populated with “Load States From Animator Controller” button 1916. Once “Tracked States” 1906 is populated, a “Tracked Objects” parameter 1908 for each state may be displayed. A “Tracked Objects” 1908 includes a “Controlled Object” 1910 which is a link to any virtual reality simulation object that may be either enabled or disabled, a “Clip Event Time” 1912 which is the time in seconds that the change will occur, and “Enabled” 1914 which determines if the object is enabled or disabled at that time. Each state can have any number of “Tracked Objects.”

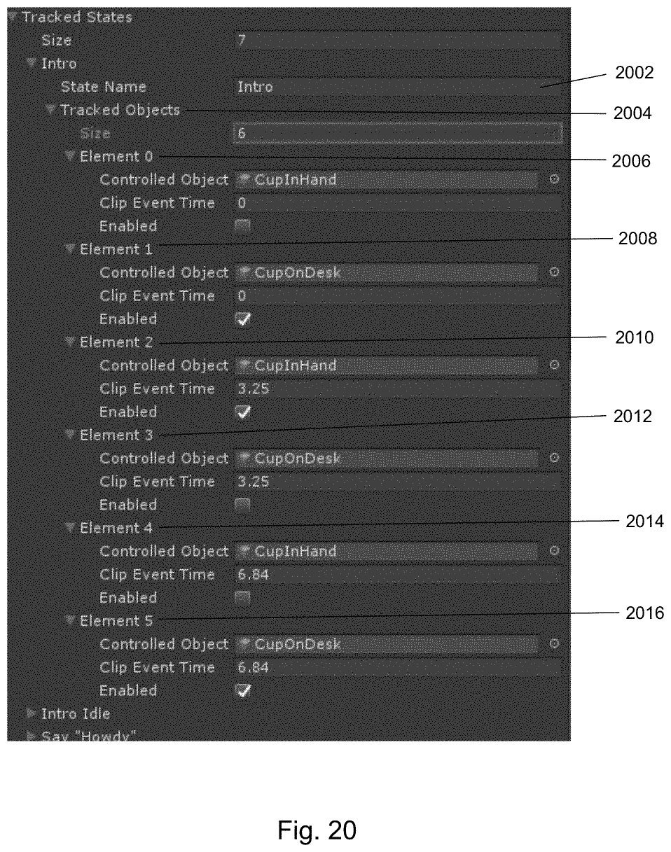

FIG. 20 presents exemplary tracked objects of an animator object sync script according to an embodiment of the present invention. The tracked objects 2004 may correspond to a partner character grabbing a cup of coffee off a desk, taking a sip, and replacing it during an intro state 2002. In “Intro” 2002, there may be 6 tracked object slots. The first two, 2006 and 2008, may be to set an initial state at time ‘0’ of the two objects. The second two, 2010 and 2012, may be for enabling the hand cup and disabling the desk cup at 3.25 seconds. The last two, 2014 and 2016, may be for enabling the desk cup and disabling the hand cup at 6.84 seconds. The activation states are as such: start with the desk cup enabled for 2006 and the cup in his hand disabled for 2008; at the 3.25 seconds time point at which he grabs the cup, enable the cup in his hand for 2010 and disable the cup on the desk for 2012; after sipping from the cup at the 6.84 seconds time point where he puts it down, enable the cup on the desk for 2016 and disable the cup in his hand for 2014.

Alternatively, two “Animator Object Sync” scripts may be used, one for each item. One sync script may have the 3 enable or disable states for the “CupInHand,” and the other would have the 3 states for “CupOnDesk.” Depending on if items are synchronized or if they are parented to related objects, it may make more sense to track their activations separately or together. Due to these objects representing the same item in the user's reality (they perceive only one cup), this is an example of using one animator object sync script for the two objects.

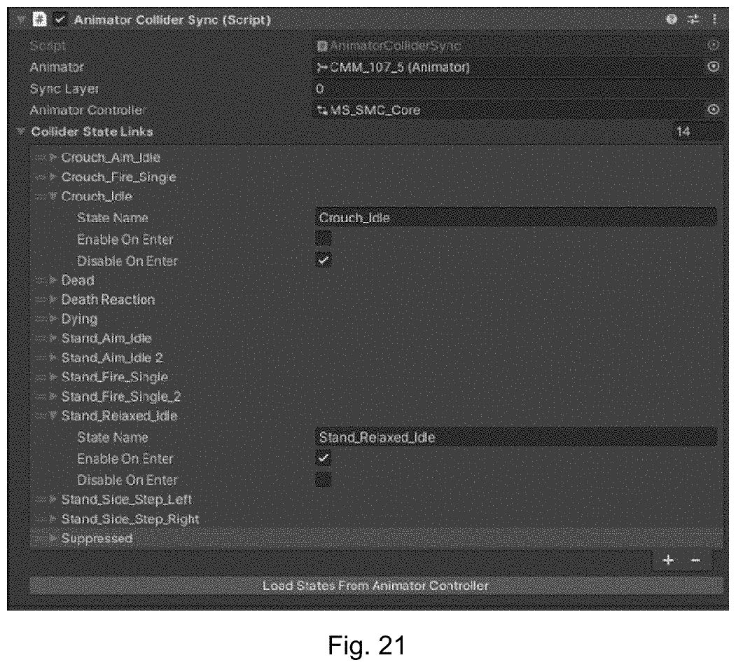

FIG. 21 presents an exemplary animator collider sync script according to an embodiment of the present invention. An animator collider sync script may control the enabling and disabling of colliders on an object based on a current state of an animator controller. This script can be primarily used to control the functionality of collision triggers at various points of a scenario.

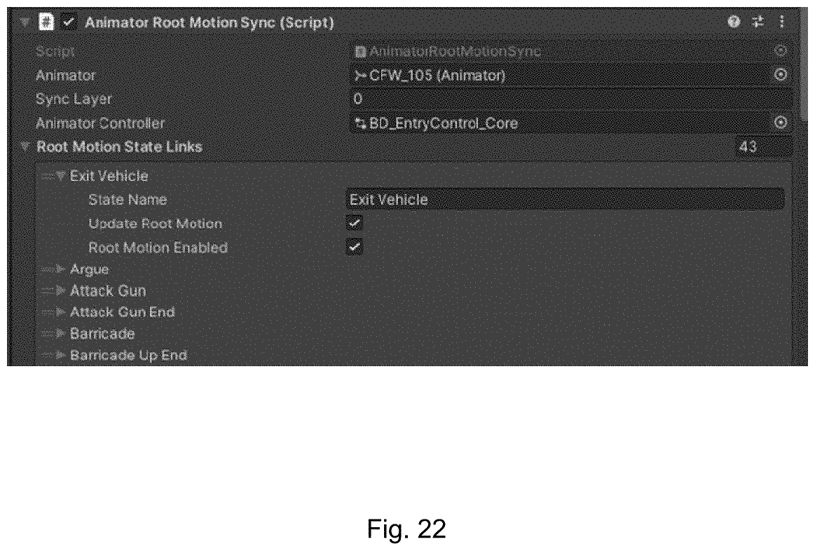

FIG. 22 presents an exemplary animator root motion sync script according to an embodiment of the present invention. A “root motion” function may be used to update a character's overall position and rotation as a scene plays out. However, if a character is attached to another object (riding in a vehicle, for example) root motion is preferably disabled. The illustrated animator root motion sync script may be used to control this condition by enabling or disabling the root motion function based on a current state of the animator controller. This may be necessary for situations where transitioning between these modes is necessary such as entering or leaving a vehicle mid scenario.

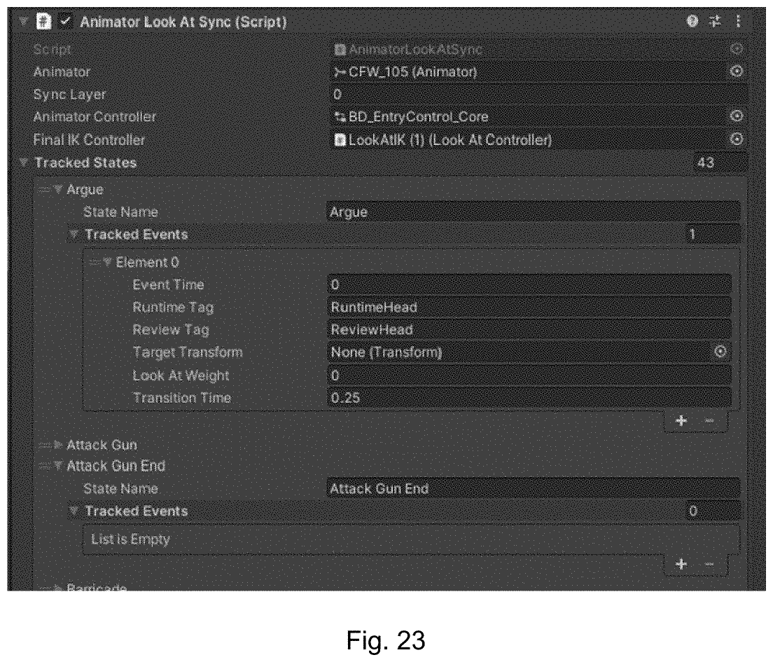

FIG. 23 presents an exemplary animator look at sync script according to an embodiment of the present invention. A look at function may be used to allow characters to look at, point at, aim at, and swing at various targets within the scenario in combination with their animations. This function may allow a scenario creator to set and smoothly transition between targets within the scenario. The illustrated animator look at sync script may allow the scenario creator to set any number of targets at various times during a state and smoothly transition between them over time.

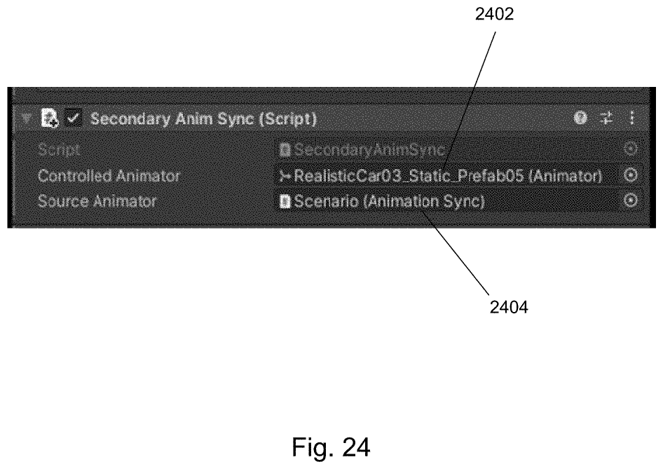

FIG. 24 presents an exemplary secondary animation sync script according to an embodiment of the present invention. The illustrated secondary animation sync script may allow for additional animated characters or objects to utilize unique animator controllers that are not overrides of an original animator controller. The secondary animation sync script may synchronize the parameters of two otherwise unrelated controllers. For example, by adding parameters “Howdy” and “Punch” to a second animation controller, as described in previously with reference to FIGS. 9 and 10, the secondary animation sync script can update the secondary controller whenever the original is updated. This allows for uniquely controlled characters to react or interact at key points in a scenario while following animations otherwise unrelated to the main action. Example include non-player characters (NPCs) stopping their idle loop to react to a death in scene or a vehicle pulling up and waiting until a character state has been reached and then driving away without needing to track any state changes in between. The secondary animation sync script requires a target animator controller 2402 as well as a core animation sync script 2404.

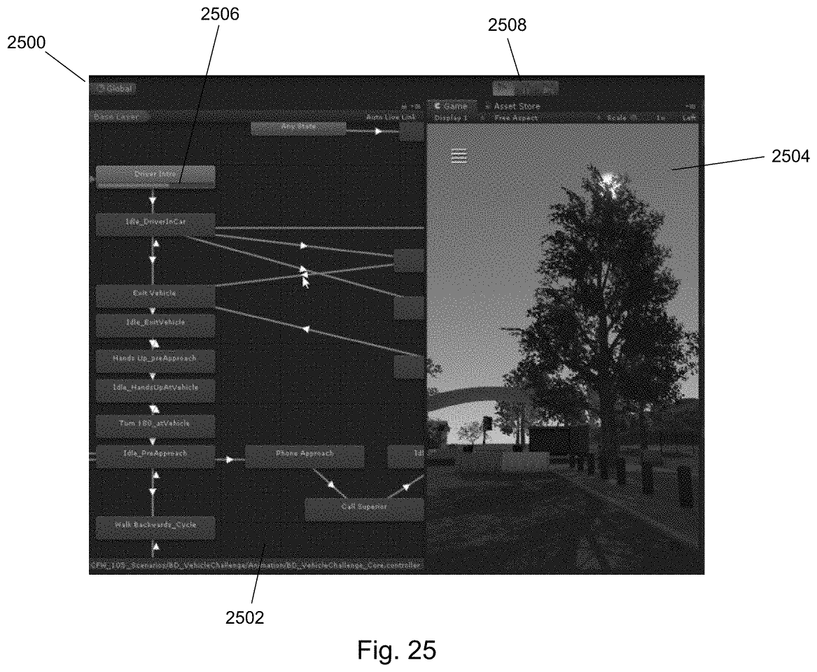

FIG. 25 presents exemplary previewing within a dynamic scenario editor according to an embodiment of the present invention. Dynamic scenario editor 2500 may include a state view 2502 of animator states for a given scenario. The animator states may be previewed on scenario display 2504 by toggling playback settings 2508 to render a sequence of states indicated in state view 2502. Playback settings 2508 include play, pause, and next navigation functionality. Playback progression of a currently played state rendered on scenario display 2504 may be indicated by a progression indicator 2506.

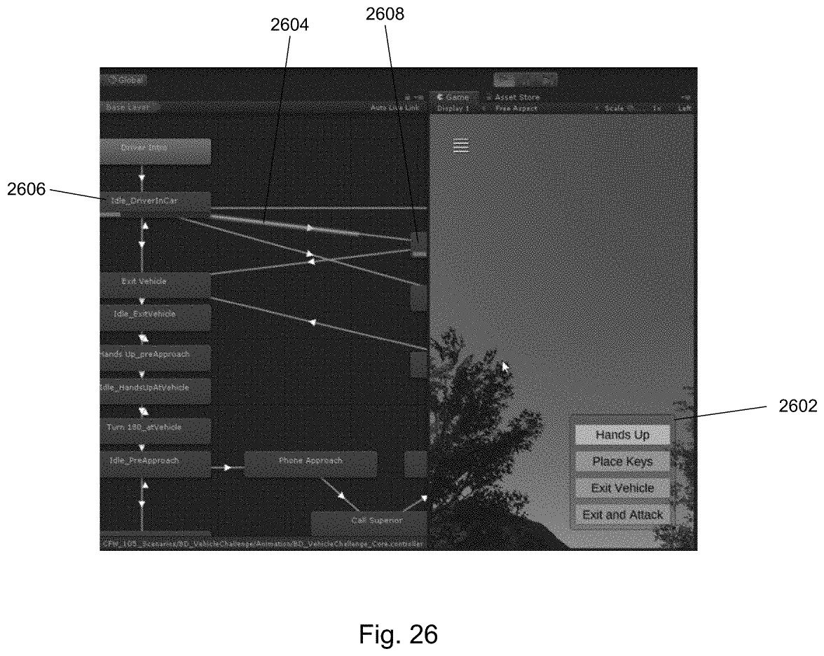

Referring to FIG. 26, playback of a state may present options 2602 which determines a transition from the current state. A selection of options 2602 may be indicated by highlight or emphasizing a transition 2604 from origin state 2606 to destination state 2608.

FIGS. 1 through 26 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A virtual reality computing system for creating dynamic scenarios, the system comprising:
a processor; and
a memory having executable instructions stored thereon that when executed by the processor cause the processor to:
execute virtual reality training software including a scenario editor that is selected by a user to create a dynamic scenario;
generate the dynamic scenario by creating a folder including customizable files corresponding to a scene of the dynamic scenario;
create a window including a project view of the customizable files that provides access to properties of a scenario information file including configurable scenario settings; and
generate animator controllers including state machines that are linked with animated characters or items, the animator controllers controlling animation behaviors of the animated characters or items in the dynamic scenario.

2. The virtual reality computing system of claim 1 wherein the animator controllers include configurable machine states corresponding to the animated characters or items.

3. The virtual reality computing system of claim 2 wherein the animator controllers are configured to control flow between the configurable states based on transitions and parameters.

4. The virtual reality computing system of claim 3 wherein the configurable machine states include actions and idles of the animated characters or items.

5. The virtual reality computing system of claim 1 further comprising the processor configured to use transitions to control flow between machine states corresponding to the animated characters or items via the animator controllers.

6. The virtual reality computing system of claim 5 further comprising the processor configured to graphically rendering the transitions with line arrows between an origin state and a destination state.

7. The virtual reality computing system of claim 1 further comprising the processor configured to generate an animator override controller object, the animator override controller object synchronizing animated characters or items from a plurality of the animator controllers.

8. The virtual reality computing system of claim 1 further comprising the processor configured to generate animator audio sync scripts, the animator audio sync scripts adding sound to the dynamic scenario.

9. The virtual reality computing system of claim 8 wherein the animator audio sync scripts associate audio sources with animation data objects of the animated characters or items.

10. The virtual reality computing system of claim 8 wherein the animator audio sync scripts associate audio sources with the animator controllers.

11. A method, in a data processing system comprising a processor and a memory, for creating dynamic scenarios, the method comprising:
executing, by a processing device, virtual reality training software including a scenario editor that is selected by a user to create a dynamic scenario;
generating, by the processing device, the dynamic scenario by creating a folder including customizable files corresponding to a scene of the dynamic scenario;
creating, by the processing device, a window including a project view of the customizable files that provides access to properties of a scenario information file including configurable scenario settings; and
generating, by the processing device, animator controllers including state machines that are linked with animated characters or items, the animator controllers controlling animation behaviors of the animated characters or items in the dynamic scenario.

12. The method of claim 11 wherein the animator controllers include configurable machine states corresponding to the animated characters or items.

13. The method of claim 11 further comprising controlling flow between machine states corresponding to the animated characters or items with transitions via the animator controllers.

14. The method of claim 13 graphically rendering the transitions with line arrows between an origin state and a destination state.

15. The method of claim 11 further comprising generating an animator override controller object, the animator override controller object synchronizing animated characters or items from a plurality of the animator controllers.

16. The method of claim 11 further comprising generating animator audio sync scripts, the animator audio sync scripts adding sound to the dynamic scenario.

17. The method of claim 16 wherein the animator audio sync scripts associate audio sources with animation data objects of the animated characters or items.

18. The method of claim 16 wherein the animator audio sync scripts associate audio sources with the animator controllers.
